(19) United States
(12) Patent Application Publication
(10) Pub. No.: US 2018/0317524 A1
(43) Pub. Date: Nov. 8, 2018

(54) METHOD AND APPARATUS FOR NITROGEN GAS INFUSED COLD BREW BEVERAGES

(71) Applicant: Lancer Corporation, San Antonio, TX (US)

(72) Inventor: Jarrell L. Jennings, III, Seguin, TX (US)

(73) Assignee: Lancer Corporation, San Antonio, TX (US)

(21) Appl. No.: 15/915,492

(22) Filed: Mar. 8, 2018

Related U.S. Application Data
(60) Provisional application No. 62/501,271, filed on May 4, 2017.

(51) Int. Cl. A23L 2/54; B01F 3/04; B01F 15/00; A23F 5/24; A47J 31/60; B01F 5/04; B01F 3/08; B67D 1/00; B67D 1/07; B67D 1/08; B67D 1/12

(52) U.S. Cl. CPC A23L 2/54; B67D 2001/0092; B01F 15/00422; B01F 15/00285; A23F 5/243; A47J 31/60; B01F 5/0403; B01F 3/0865; B67D 1/0021; B67D 1/0043; B67D 1/07; B67D 1/0857; B67D 1/1252; B67D 1/1281; B01F 2003/04921; A23V 2002/00; B01F 3/04808

(57) ABSTRACT

A dispenser of nitrogen gas infused cold brew beverages includes a product container, a nitrogenator, a mixing unit, and a dispensing unit. The nitrogenator receives water from a water source and nitrogen gas from a nitrogen gas source and infuses the nitrogen gas into the water to produce nitrogen gas infused water. The mixing unit receives product from a product container and nitrogen gas infused water from the nitrogenator. The mixing unit combines the product and the nitrogen gas infused water to induce a mixing thereof that creates a nitrogen gas infused beverage. The dispensing unit receives nitrogen gas infused beverage from the mixing unit. The dispensing unit chills the nitrogen gas infused beverage to produce a nitrogen gas infused cold brew beverage for dispensing therefrom.

### CROSS-REFERENCE TO RELATED APPLICATION

This present application claims all available benefit, under 35 U.S.C. § 119(e), of U.S. provisional patent application Ser. No. 62/501,271, which was filed May 4, 2017. By this reference, the full disclosure of U.S. provisional patent application Ser. No. 62/501,271 is incorporated herein as though now set forth in its entirety.

### BACKGROUND OF THE INVENTION

### 1. Field of the Invention

The present invention relates to nitrogen gas infused cold brew beverages, such as coffee, and, more particularly, but not by way of limitation, to a dispenser for nitrogen gas infused cold brew beverages and a method for dispensing thereof.

### 2. Description of the Related Art

Nitrogen gas infused cold brew beverages such as coffee continue to increase in popularity, creating a demand in the food/drink dispensing industry for dispensers suitable to dispense such beverages. One nitrogen gas infused cold brew coffee dispenser includes a cooling cabinet containing therein a tank filled with coffee. The tank connects at an inlet with a source of nitrogen gas that delivers nitrogen gas into the tank for infusion into the coffee within the tank. The tank connects at an outlet with a faucet secured to the cooling cabinet whereby the faucet delivers nitrogen gas infused cold brew coffee from the tank. Although the dispenser delivers nitrogen gas infused cold brew coffee, combining the nitrogen gas with the coffee in the tank results in a less than satisfactory infusion of the nitrogen gas into the coffee. Moreover, the size of the cooling cabinet limits the venues acceptable for use of the dispenser.

Another nitrogen gas infused cold brew coffee dispenser includes a contactor membrane unit coupled at a gas inlet with a source of nitrogen gas and at a liquid inlet with a pump connected with a tank filled with coffee. The contactor membrane unit receives coffee from the tank via the pump and nitrogen gas from the source of nitrogen gas and contacts the nitrogen gas with the coffee in order to infuse the coffee with the nitrogen gas. The contactor membrane unit connects at an outlet with a faucet securable to a counter whereby the faucet delivers nitrogen gas infused cold brew coffee from the contactor membrane unit. Although the dispenser delivers nitrogen gas infused cold brew coffee, the use of a contactor membrane unit to infuse the coffee with nitrogen gas creates a sanitation issue in that cleaning the contactor membrane unit to prevent bacterial growth within the dispenser can be difficult.

Accordingly, a dispenser with small space requirements that delivers a quality nitrogen gas infused cold brew beverage while offering easy and effective cleaning will improve over prior dispensers.

### SUMMARY OF THE INVENTION

In accordance with the present invention, a dispenser makes nitrogen gas infused water and then combines the nitrogen gas infused water with a product to create a nitrogen gas infused beverage. The dispenser further chills the nitrogen gas infused beverage to produce a nitrogen gas infused cold brew beverage for dispensing therefrom.

The dispenser in a preferred embodiment includes a product container, a nitrogenator, a mixing unit, and a dispensing unit. The nitrogenator receives water from a water source and nitrogen gas from a nitrogen gas source and infuses the nitrogen gas into the water to produce nitrogen gas infused water. The mixing unit receives product from the product container and nitrogen gas infused water from the nitrogenator. The mixing unit combines the product and the nitrogen gas infused water to induce a mixing thereof that creates a nitrogen gas infused beverage. The dispensing unit receives nitrogen gas infused beverage from the mixing unit and chills the nitrogen gas infused beverage to produce a nitrogen gas infused cold brew beverage for dispensing therefrom.

The product container holds any product suitable for combining with nitrogen gas infused water to make a nitrogen gas infused cold brew beverage. Suitable product includes but is not limited to a coffee concentrate or a previously made cold brewed coffee.

The nitrogenator includes a water regulator, a water pump, and a tank. The water regulator includes an inlet coupled with the water source to receive water therefrom and an outlet. The water regulator ensures water pressure does not exceed a desired pressure. The water pump includes an inlet coupled with the outlet of the water regulator and an outlet. The tank includes a water inlet coupled with the outlet of the water pump to receive therein water delivered from the pump. The tank further includes a gas inlet coupled with the nitrogen gas source to receive gas therefrom. The tank contacts the nitrogen gas with the water and induces infusion of the nitrogen gas into the water to produce nitrogen gas infused water. The tank at an outlet delivers the nitrogen gas infused water to the mixing unit.

The mixing unit includes a product flow control assembly coupled with the product container to receive product therefrom, a nitrogenated water flow control assembly coupled with the nitrogenator to receive nitrogen gas infused water therefrom, and a mixer. The mixer couples with the product flow control assembly to receive product therefrom and with the nitrogenated water flow control assembly to receive nitrogen gas infused water therefrom. The mixer combines the product and the nitrogen gas infused water to induce a mixing thereof that creates a nitrogen gas infused beverage. The mixing unit further includes a housing that receives the product flow control assembly, the nitrogenated water flow control assembly, and the mixer therein and a cover that fits over the housing to provide a seal therefor.

The mixer includes a product line segment, a nitrogenated water line segment, and a mixing line segment. The product line segment includes a product inlet coupled with the product flow control assembly to receive product therefrom. The nitrogenated water line segment includes a nitrogenated water inlet coupled with the nitrogenated water flow control assembly to receive nitrogen gas infused water therefrom. The product line segment and the nitrogenated water line segment merge at the mixing line segment to deliver product and nitrogen gas infused water thereto. The mixing line segment contacts the product with the nitrogen gas infused water resulting in the mixing of the product and the nitrogenated water into a nitrogen gas infused beverage. The mixing line segment terminates in a beverage outlet coupled with the dispensing unit to deliver nitrogen gas infused beverage thereto.

The mixer in a preferred embodiment includes a U-shaped tube and an outlet tube joined therewith. The U-shaped tube includes a first inlet coupled with the product flow control assembly to receive product therefrom and a second inlet coupled with the nitrogenated water flow control assembly to receive nitrogen gas infused water therefrom. The outlet tube contacts the product with the nitrogen gas infused water resulting in the mixing of the product and the nitrogenated water into a nitrogen gas infused beverage. The outlet tube terminates in a beverage outlet coupled with the dispensing unit to deliver nitrogen gas infused beverage thereto.

The product flow control assembly includes a flow rate controller having an inlet coupled with the product container to receive product therefrom and an outlet coupled with the mixer to deliver product thereto. The flow rate controller is adjustable to increase product flow rate therethrough such that an increasing amount of product delivered to the mixer enhances nitrogen gas infused beverage strength. In particular, when a sample of dispensed nitrogen gas infused cold brew beverage indicates insufficient strength thereof, the flow rate controller is adjusted to increase product flow rate therethrough thereby enhancing nitrogen gas infused cold brew beverage strength. The flow rate controller further is adjustable to decrease product flow rate therethrough such that a decreasing amount of product delivered to the mixer diminishes nitrogen gas infused beverage strength. In particular, when a sample of dispensed nitrogen gas infused cold brew beverage indicates excess strength thereof, the flow rate controller is adjusted to decrease product flow rate therethrough thereby diminishing nitrogen gas infused cold brew beverage strength.

The product flow control assembly further includes a shut-off valve and a check valve. The shut-off valve includes an inlet coupled with the product container to receive product therefrom and a product outlet coupled with the inlet of the flow controller. The shut-off valve includes an open position that allows product flow to the flow controller and a closed position that blocks product flow to the flow controller. The check valve includes an inlet coupled with the outlet of the flow controller and an outlet coupled with the mixer. The check valve permits product flow to the mixer while preventing back-flow of product or nitrogen gas infused water to the flow controller.

The nitrogenated water flow control assembly includes a flow rate controller having an inlet coupled with the nitrogenator to receive nitrogen gas infused water therefrom and an outlet coupled with the mixer to deliver nitrogen gas infused water thereto. The flow rate controller is adjustable to increase nitrogen gas infused water flow rate therethrough such that an increasing amount of nitrogen gas infused water delivered to the mixer diminishes nitrogen gas infused beverage strength. In particular, when a sample of dispensed nitrogen gas infused cold brew beverage indicates excess strength thereof, the flow rate controller is adjusted to increase nitrogen gas infused water flow rate therethrough thereby diminishing nitrogen gas infused cold brew beverage strength. The flow rate controller further is adjustable to decrease nitrogen gas infused water flow rate therethrough such that a decreasing amount of nitrogen gas infused water delivered to the mixer enhances nitrogen gas infused beverage strength. In particular, when a sample of dispensed nitrogen gas infused cold brew beverage indicates insufficient strength thereof, the flow rate controller is adjusted to decrease nitrogen gas infused water flow rate therethrough thereby enhancing nitrogen gas infused cold brew beverage strength.

The product flow control assembly further includes a regulator, a shut-off valve, and a check valve. The regulator includes an inlet coupled with the nitrogenator to receive nitrogen gas infused water therefrom and an outlet coupled with the inlet of the flow controller. The regulator ensures nitrogen gas infused water pressure does not exceed a desired pressure. The shut-off valve includes an inlet coupled with the outlet of the regulator and an outlet coupled with the inlet of the flow controller. The shut-off valve includes an open position that allows nitrogen gas infused water flow to the flow controller and a closed position that blocks nitrogen gas infused water flow to the flow controller. The check valve includes an inlet coupled with the outlet of the flow controller and an outlet coupled with the mixer. The check valve permits nitrogen gas infused water flow to the mixer while preventing back-flow of product or nitrogenated water to the flow controller.

The dispensing unit includes a housing, a cooling system disposed in the housing, and a faucet disposed on the housing. The cooling system is coupled with the mixing unit to receive nitrogen gas infused beverage therefrom. The cooling system chills the nitrogen gas infused beverage to produce a nitrogen gas infused cold brew beverage. The faucet is coupled with the cooling system to control delivery of nitrogen gas infused cold brew beverage therefrom.

The dispenser further includes a pump coupled between the product container and the mixing unit to deliver product from the product container to the mixing unit. Cleaning of the dispenser includes decoupling the pump from the product container and coupling the pump with a cleaning solution container such that the pump delivers cleaning solution through the pump, the mixing unit, and the dispensing unit to facilitate cleaning thereof. The pump in a preferred embodiment is a gas powered pump driven by nitrogen gas delivered thereto from the nitrogen gas source.

The nitrogen gas source includes a canister filled with nitrogen gas and a gas regulator. The gas regulator includes a product side regulator coupled with the pump to deliver nitrogen gas thereto at a desired pressure and a nitrogenator side regulator coupled with the gas inlet of the tank to deliver nitrogen gas thereto at a desired pressure.

In a method of dispensing nitrogen gas infused cold brew beverages, a nitrogen gas is infused into water to produce nitrogen gas infused water. A product and the nitrogen gas infused water are delivered to a mixing unit that induces mixing of the product and the nitrogen gas infused water to create a nitrogen gas infused beverage. The nitrogen gas infused beverage is delivered to a dispensing unit that cools the nitrogen gas infused beverage to produce a nitrogen gas infused cold brew beverage dispensed from the dispensing unit.

The delivery of product to the mixing unit includes delivering the product to a product flow control assembly of the mixing unit while a dispensed nitrogen gas infused cold brew beverage is sampled to determine a strength thereof. In response to a determination of insufficient strength, product flow rate is increased using the product flow control assembly wherein an increased product flow rate delivers an increasing amount of product thereby enhancing nitrogen gas infused cold brew beverage strength. In response to a determination of excess strength, product flow rate is decreased using the product flow control assembly wherein a decreased product flow rate delivers a decreasing amount of product thereby diminishing nitrogen gas infused cold brew beverage strength.

The delivery of nitrogen gas infused water to the mixing unit includes delivering nitrogen gas infused water to a nitrogenated water flow control assembly of the mixing unit while a dispensed nitrogen gas infused cold brew beverage is sampled to determine a strength thereof. In response to a determination of excess strength, nitrogen gas infused water flow rate is increased using the nitrogenated water flow control assembly wherein an increased nitrogen gas infused water flow rate delivers an increasing amount of nitrogen gas infused water thereby diminishing nitrogen gas infused cold brew beverage strength. In response to a determination of insufficient strength, nitrogen gas infused water flow rate is decreased using the nitrogenated water flow control assembly wherein a decreased nitrogen gas infused water flow rate delivers a decreasing amount of nitrogen gas infused water thereby enhancing nitrogen gas infused cold brew beverage strength.

In the method of dispensing nitrogen gas infused cold brew beverages, product is delivered to a product flow control assembly of the mixing unit and nitrogen gas infused water is delivered to a nitrogenated water flow control assembly of the mixing unit. The product flow control assembly and the nitrogenated water flow control assembly merge at a mixer of the mixing unit that induces a mixing of product and nitrogen gas infused water to create a nitrogen gas infused beverage. In a preferred embodiment, the product flow control assembly delivers product to a first inlet of a U-shaped tube while the nitrogenated water flow control assembly delivers nitrogen gas infused water to a second inlet of the U-shaped tube. The U-shaped tube delivers product and nitrogen gas infused water to an outlet tube joined with the U-shaped tube that induces a mixing of product and nitrogen gas infused water to create a nitrogen gas infused beverage.

A cleaning method includes ceasing delivery of product to the mixing unit followed by delivering a cleaning solution to the mixing unit. The cleaning method further includes delivering the cleaning solution from the mixing unit to the dispensing unit and then dispensing the cleaning solution from the dispensing unit thereby cleaning the mixing unit and the dispensing unit.

It is therefore an object of the present invention to provide a dispenser with small space requirements that delivers a quality nitrogen gas infused cold brew beverage.

It is another object of the present invention to provide a dispenser offering easy and effective cleaning.

Still other objects, features, and advantages of the present invention will become evident to those of ordinary skill in the art in light of the following. Also, it should be understood that the scope of this invention is intended to be broad, and any combination of any subset of the features, elements, or steps described herein is part of the intended scope of the invention.

### BRIEF DESCRIPTION OF DRAWINGS

FIG. 1 is a schematic diagram illustrating a nitrogen gas infused cold brew beverage dispenser according to the preferred embodiment.

FIGS. 2 and 3 are isometric views illustrating a mixing unit of the nitrogen gas infused cold brew beverage dispenser.

FIG. 4 is an exploded isometric view illustrating the mixing unit of the nitrogen gas infused cold brew beverage dispenser.

FIG. 5 is an isometric view illustrating a dispensing unit of the nitrogen gas infused cold brew beverage dispenser.

FIG. 6 is an exploded isometric view illustrating the dispensing unit of the nitrogen gas infused cold brew beverage dispenser.

### DETAILED DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. Figures are not necessarily to scale, and some features may be exaggerated to show details of particular components or steps.

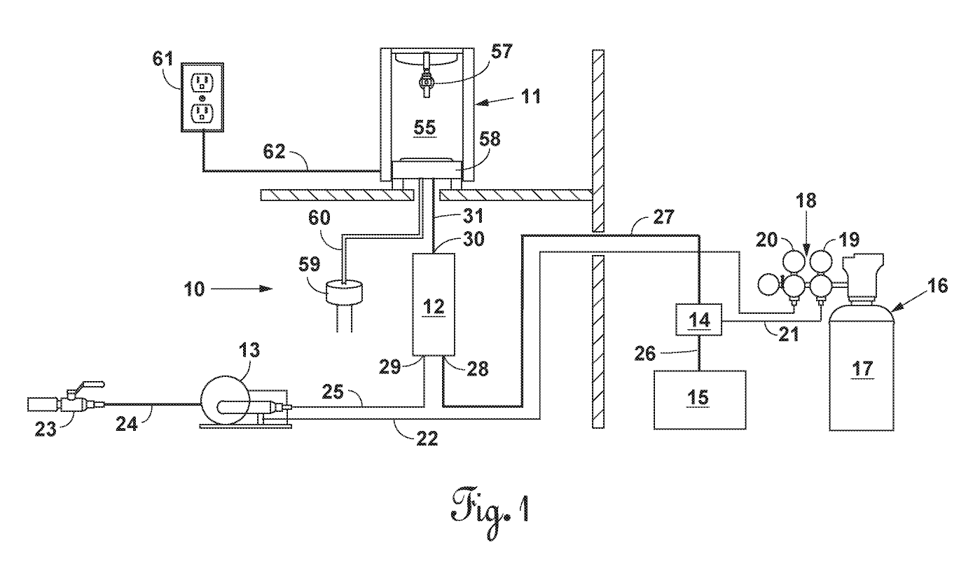

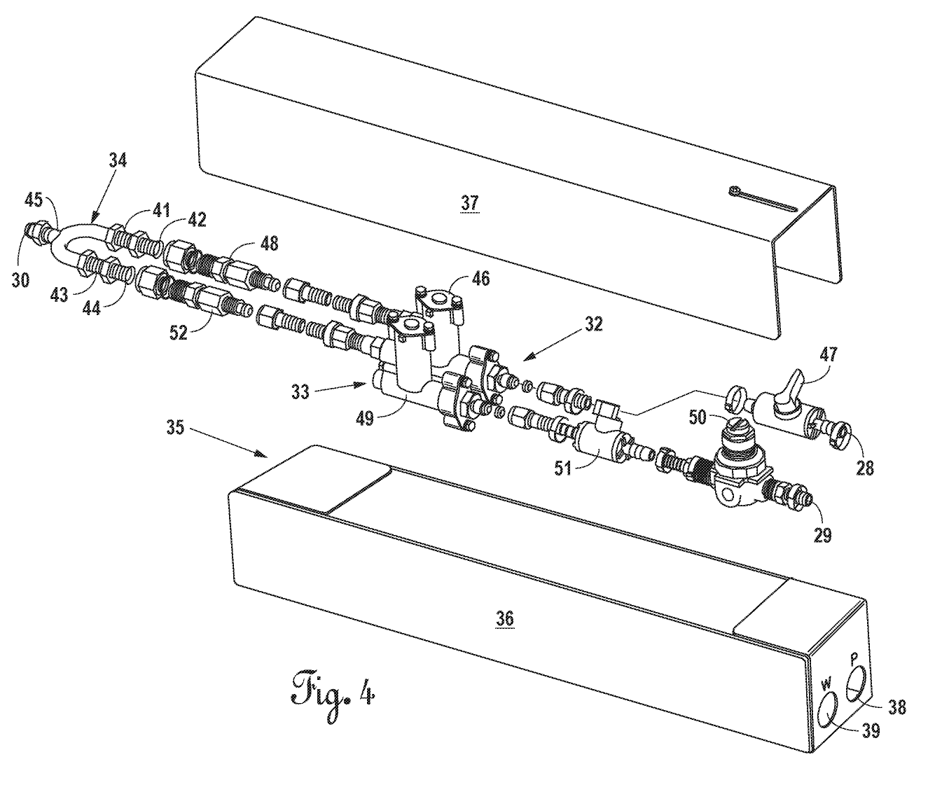

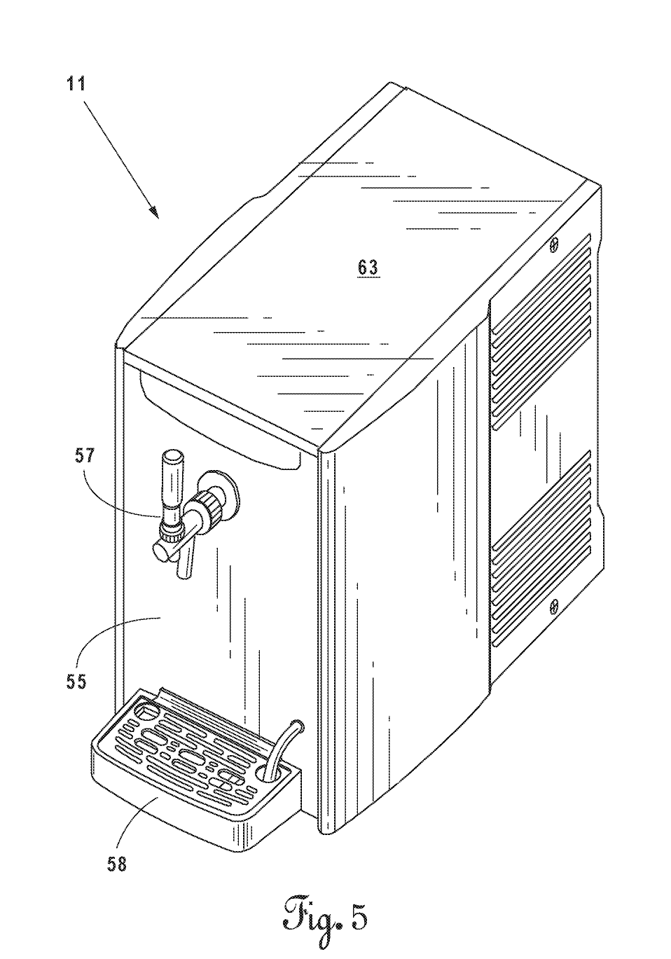

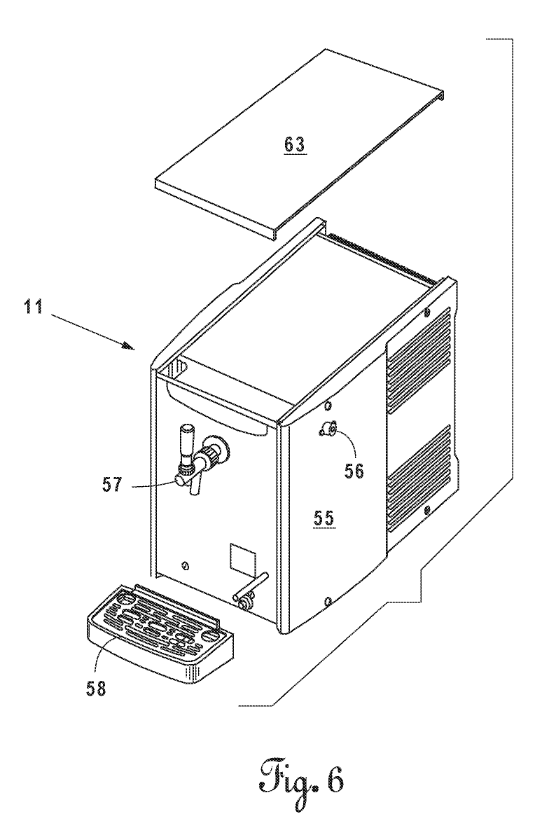

As illustrated in FIGS. 1-6, the present invention as set forth in the following preferred embodiment is a dispenser 10 of nitrogen gas infused cold brew beverages such as nitrogen gas infused cold brew coffee. The dispenser 10 includes a dispensing unit 11, a mixing unit 12, and a nitrogenator 13. In the preferred embodiment, the dispenser 10 includes a pump 14 that delivers a product from a product container 15 and a nitrogen gas source 16 that delivers nitrogen gas to the nitrogenator 13 and to the pump 14 for the powering thereof.

The nitrogen gas source 16 in the preferred embodiment includes any suitable canister 17 filled with nitrogen gas and a gas regulator 18 connected therewith. The gas regulator 18 regulates the pressure of nitrogen gas delivered from the canister 17. In particular, the gas regulator 18 includes a product side regulator 19 and a nitrogenator side regulator 20. The product side regulator 19 connects with the pump 14 using any suitable gas line 21 to deliver nitrogen gas thereto at a desired pressure of 80 psi in the preferred embodiment. Similarly, the nitrogenator side regulator 20 connects with the nitrogenator 13 using any suitable gas line 22 to deliver nitrogen gas thereto at a desired pressure of 70 psi in the preferred embodiment.

The nitrogenator 13 in addition to its connection with the nitrogen gas source 16 via gas line 22 connects with a water source 23 via a water line 24. The water source 23 in the preferred embodiment is a public water system, and the water delivered therefrom may be filtered if necessary. The nitrogenator 13 receives water from the water source 23 and nitrogen gas from the nitrogen gas source 16 and facilitates the infusion of the nitrogen gas into the water to produce nitrogen gas infused water (hereinafter referred to as nitrogenated water). The nitrogenator 13 in the preferred embodiment includes a water regulator, a water pump, and a tank. The water regulator connects an inlet of the water pump with the water source 23 in order to maintain the pressure of the water delivered from the water source at a desired pressure of 50 psi in the preferred embodiment. The outlet of the water pump connects with a water inlet of the tank to deliver water thereto. The gas line 22 connects with a gas inlet of the tank to deliver gas thereto. The tank contacts the nitrogen gas with the water and induces infusion of the nitrogen gas into the water to produce nitrogenated water. The tank at a nitrogenated water outlet connects with the mixing unit 12 via a nitrogenated water line 25 to deliver nitrogenated water thereto. In the preferred embodiment, the nitrogenator 13 is any suitable gas/water infusion device such as the Lancer Nitrogenator Model 85-1933-00 available from Lancer Corporation, 6655 Lancer Blvd., San Antonio, Tex. 78219.

The product container 15 holds any product suitable for combining with nitrogenated water to make a nitrogen gas infused cold brew beverage. A product suitable for combining with nitrogenated water includes coffee, which is combined with the nitrogenated water to produce nitrogen gas infused cold brew coffee. The product may be a product in a concentrate form, such as a coffee concentrate, or a fully made product, such as previously made cold brewed coffee.

The pump 14 in addition to its connection at a gas inlet with the nitrogen gas source 16 via gas line 21 connects at a product inlet with the product container 15 via a product line 26. The pump 14 at a product outlet connects with the mixing unit 12 via a product line 27 to deliver product thereto. In the preferred embodiment, the pump 14 is any suitable gas powered pump such as the Flojet Model P50005 available from Flojet, 12 Morgan, Irvine, Calif. 92618. Nevertheless, while the pump 14 in the preferred embodiment is a gas-powered pump, one of ordinary skill in the art will recognize that any pump suitable to pump product may be used to implement the pump 14. The nitrogen gas delivered to the pump 14 from the nitrogen gas source 16 powers a reciprocating piston such that the pump 14 pumps product from the product container 15 via the product line 26 and delivers the product to the mixing unit 12 via the product line 27.

The mixing unit 12 includes a product inlet 28 connected with the pump 14 via the product line 27 to receive product therein. Likewise, the mixing unit 12 includes a nitrogenated water inlet 29 connected with the nitrogenator 13 via the nitrogenated water line 25 to receive nitrogenated water therein. The mixing unit 12 further includes a beverage outlet 30 connected with the dispensing unit 11 via a beverage line 31 to deliver a nitrogen gas infused beverage thereto. The mixing unit 12 receives the product and the nitrogenated water therein and combines the product and the nitrogenated water to produce a mixing thereof that creates a nitrogen gas infused beverage. The mixing unit 12 via its beverage outlet 30 and the beverage line 31 deliver the nitrogen gas infused beverage to the dispensing unit 11 for dispensing therefrom.

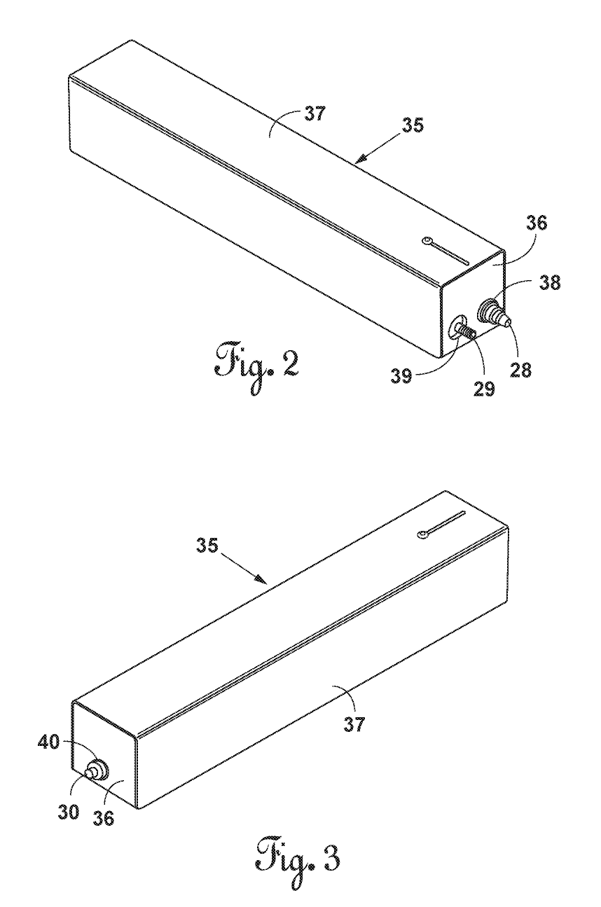

As illustrated by FIGS. 2-4, the mixing unit 12 includes a product flow control assembly 32, a nitrogenated water flow control assembly 33, and a mixer 34. The mixing unit 12 further includes a housing 35 having a box 36 that receives the product flow control assembly 32, the nitrogenated water flow control assembly 33, and the mixer 32 therein and a cover 37 that fits over the box 36 to provide a seal therefor. The box 36 at an inlet end includes an aperture 38 that receives the product inlet 28 therethrough and an aperture 39 that receives the nitrogenated water inlet 29 therethrough. The box 36 at an outlet end includes an aperture 40 that receives the beverage outlet 30 therethrough.

The mixer 34 includes a product line segment 41 having a product inlet 42 and a nitrogenated water line segment 43 having a nitrogenated water inlet 44. The product line segment 41 and the nitrogenated water line segment 43 merge at a mixing line segment 45 to contact the product with the nitrogenated water resulting in the mixing of the product and the nitrogenated water into a nitrogen gas infused beverage. The mixing line segment 45 terminates in the beverage outlet 30 that extends through the aperture 40. In the preferred embodiment, the mixer 34 comprises a U-shaped tube, which includes first and second inlets, joined with an outlet tube.

The product flow control assembly 32 includes a flow rate controller 46, which may be any suitable flow rate controller such as a flow rate control valve including a spring-loaded ceramic piston well known to one of ordinary skill in the art. The flow rate controller 46 includes an inlet coupled with the product line 27 to receive product therefrom and an outlet coupled with the product inlet 42 of the product line segment 41 for the mixer 34. The flow rate controller 46 in the preferred embodiment is adjustable to either increase or decrease the flow rate of the product through the product flow control assembly 32 and to the mixer 34. An adjustment of the flow rate controller 46 to raise the flow rate of the product increases the amount of product delivered to the mixer 34, thereby enhancing the strength of the resulting nitrogen gas infused beverage. Conversely, an adjustment of the flow rate controller 46 to lower the flow rate of the product decreases the amount of product delivered to the mixer 34, thereby diminishing the strength of the resulting nitrogen gas infused beverage.

The product flow control assembly 32 in the preferred embodiment further includes a shut-off valve 47 and a check valve 48. The shut-off valve 47 includes the product inlet 28 that extends through the aperture 38 and an outlet connected with the inlet of the flow controller 46 using any suitable fluid connectors such as adaptors, nuts, seal washers, and tubing. The shut-off valve 47 includes an open position that allows product flow to the flow controller 46 and a closed position that blocks product flow to the flow controller 46. The check valve 48 includes an inlet connected with the outlet of the flow controller 46 using any suitable fluid connectors such as adaptors, nuts, seal washers, and tubing and an outlet connected with the product inlet 42 of the product line segment 41 for the mixer 34 using any suitable fluid connectors such as adaptors, nuts, seal washers, and tubing. The check valve 48 permits product flow to the mixer 34 while preventing back-flow of product or nitrogenated water to the flow controller 46. Although the product flow control assembly 32 in the preferred embodiment includes a shut-off valve 47 and a check valve 48, one of ordinary skill in the art will recognize that the product flow control assembly 32 may comprise only the flow controller 46.

The nitrogenated water flow control assembly 33 includes a flow rate controller 49, which may be any suitable flow rate controller such as a flow rate control valve including a spring-loaded ceramic piston well known to one of ordinary skill in the art. The flow rate controller 49 includes an inlet coupled with the nitrogenated water line 25 to receive nitrogenated water therefrom and an outlet coupled with the nitrogenated water inlet 44 of the nitrogenated water line segment 43 for the mixer 34. The flow rate controller 49 in the preferred embodiment is adjustable to either increase or decrease the flow rate of the nitrogenated water through the nitrogenated water flow control assembly 33 and to the mixer 34. An adjustment of the flow rate controller 49 to raise the flow rate of the nitrogenated water increases the amount of nitrogenated water delivered to the mixer 34, thereby diminishing the strength of the resulting nitrogen gas infused beverage. Conversely, an adjustment of the flow rate controller 49 to lower the flow rate of the nitrogenated water decreases the amount of nitrogenated water delivered to the mixer 34, thereby enhancing the strength of the resulting nitrogen gas infused beverage.

The nitrogenated water flow control assembly 33 in the preferred embodiment further includes a regulator 50, a shut-off valve 51 and a check valve 52. The regulator 50 includes the nitrogenated water inlet 29 that extends through the aperture 39 and an outlet connected with the shut-off valve 51. The regulator 50 ensures the pressure of the nitrogenated water flowing through the nitrogenated water flow control assembly 33 does not exceed a desired pressure of 80 psi in the preferred embodiment. The shut-off valve 51 includes an inlet connected with the outlet of the regulator 50 using any suitable fluid connectors such as adaptors, nuts, seal washers, and tubing and an outlet connected with the inlet of the flow controller 49 using any suitable fluid connectors such as adaptors, nuts, seal washers, and tubing. The shut-off valve 51 includes an open position that allows nitrogenated water flow to the flow controller 49 and a closed position that blocks nitrogenated water flow to the flow controller 49. The check valve 52 includes an inlet connected with the outlet of the flow controller 49 using any suitable fluid connectors such as adaptors, nuts, seal washers, and tubing and an outlet connected with the with the nitrogenated water inlet 44 of the nitrogenated water line segment 43 for the mixer 34 using any suitable fluid connectors such as adaptors, nuts, seal washers, and tubing. The check valve 52 permits nitrogenated water flow to the mixer 34 while preventing back-flow of nitrogenated water or product to the flow controller 49. Although the nitrogenated water flow control assembly 33 in the preferred embodiment includes a regulator 50, a shut-off valve 51, and a check valve 52, one of ordinary skill in the art will recognize that the nitrogenated water flow control assembly 33 may comprise only the flow controller 49.

The dispensing unit 11 receives the nitrogen gas infused beverage from the mixing unit 12 via the beverage line 31 and chills the nitrogen gas infused beverage to produce a nitrogen gas infused cold brew beverage prior to the dispensing thereof to a consumer. As illustrated by FIGS. 1 and 5-6, the dispensing unit 11 includes a housing 55 having a beverage inlet 56 securable with the beverage line 31, a lid 63 for the housing 55, a cooling system disposed in the housing 55, a faucet 57 secured with the housing 55, and a drain pan 58 connected with the housing 55. The cooling system in the preferred embodiment includes a refrigeration unit that forms an ice bank from a water bath contained within the housing 11. The cooling system further includes a cooling coil disposed in the housing 55 and secured between the beverage inlet 58 and the faucet 57. The ice bank and the water bath contained within the housing 11 chill the nitrogen gas infused beverage flowing through the cooling coil prior to its dispensing from the faucet 57 as a nitrogen gas infused cold brew beverage. The faucet 57 delivers the nitrogen gas infused cold brew beverage to a consumer's container placed underneath. The faucet 57 in the preferred embodiment is any faucet suitable to deliver a nitrogen gas infused cold brew beverage such as the Taprite Model SF2000 Series available from Taprite-Fassco Mfg., Inc., 3248 Northwestern, San Antonio, Tex. 78238. The drain pan 58 resides below the faucet 57 and connects with a drain 59 via a drain line 60 to remove spilled nitrogen gas infused cold brew beverage from the dispensing unit 11. In the preferred embodiment, the dispensing unit 11 is a counter electric dispenser, such as a Lancer NitroFusion DBF-40SAC-R available from Lancer Corporation, 6655 Lancer Blvd., San Antonio, Tex. 78219, which connects with an electrical outlet 61 via an electrical line 62 to power the refrigeration unit. Although the dispensing unit 11 is a counter electric dispenser, one of ordinary skill in the art will recognize that other types of dispensers such as cold plate ice cooled units may be utilized.

FIG. 1 illustrates an example installation of the dispenser 10 in a food/beverage establishment. The dispensing unit 11 sits atop a counter while the mixing unit 12 and the nitrogenator 13 reside underneath the counter. The pump 14, the product container 15, and the nitrogen gas source 16 are located in a back room of the establishment remote from the mixing unit 12 and the nitrogenator 13. The nitrogenator 13 connects with the nitrogen gas source 16 and the water source 23 and further with the mixing unit 12 as previously described. Likewise, the pump 14 connects with the nitrogen gas source 16 and the product container 15 and further with the mixing unit 12 as previously described. The mixing unit 12 receives product from the product container 15 via the pump 14 and nitrogenated water from the nitrogenator 13 and mixes the product and the nitrogenated water to produce a nitrogen gas infused beverage. The dispensing unit 11, which connects with the mixing unit 12 as previously described, chills the nitrogen gas infused beverage received from the mixing unit 12 prior to its delivery to a consumer as a nitrogen gas infused cold brew beverage.

Before delivering a nitrogen gas infused cold brew beverage to a consumer, the nitrogen gas infused cold brew beverage delivered from the dispensing unit 11 may be regulated with respect to strength and thus taste and flavor. An operator of the dispenser 10 dispenses a nitrogen gas infused cold brew beverage into a container and, based on the taste/flavor of the beverage in combination with its visual appearance, the operator adjusts the mixing unit 12. In particular, the operator adjusts the flow rate controller 46 of the mixing unit 12 to raise the flow rate of the product and increase the amount of product delivered to the mixer 34, thereby enhancing the strength of the resulting nitrogen gas infused beverage. Similarly, the operator adjusts the flow rate controller 49 of the mixing unit 12 to lower the flow rate of the nitrogenated water and decrease the amount of nitrogenated water delivered to the mixer 34, thereby enhancing the strength of the resulting nitrogen gas infused beverage. Conversely, the operator adjusts the flow rate controller 46 to lower the flow rate of the product and decrease the amount of product delivered to the mixer 34, thereby diminishing the strength of the resulting nitrogen gas infused beverage. Similarly, the operator adjusts the flow rate controller 49 to raise the flow rate of the nitrogenated water and increase the amount of nitrogenated water delivered to the mixer 34, thereby diminishing the strength of the resulting nitrogen gas infused beverage. The operator adjusts the flow rate controllers 46 and 49 of the mixing unit 12 until the resulting nitrogen gas infused beverage provides the desired visual appearance along with the more important desired taste and flavor. The flow rate controllers 46 and 49 deliver the product and the nitrogenated water, respectively, to the mixer 34, which contacts the product with the nitrogenated water resulting in the mixing of the product and the nitrogenated water into the nitrogen gas infused beverage. Although an operator may subjectively adjust the taste and flavor of the nitrogen gas infused beverage, one of ordinary skill in the art will recognize that specific ratios of the product relative to the nitrogenated water may be used.

The dispenser 10 provides an improvement in the dispensing of nitrogen gas infused cold brew beverages by including a mixing unit 12 with a mixer 34 that is fed from a separate nitrogenator 13 and a separate product container 15. The nitrogenator 13 ensures nitrogen gas properly infuses into the water to form the nitrogenated water delivered to the mixer 34, and the mixer 34 ensures the product mixes and substantially, completely combines with the nitrogenated water to create a nitrogen gas infused beverage. Moreover, an advantage of the dispenser 10 is the ease in its cleaning without disassembly. In particular, the pump 14 is disconnected from the product container 15 and connected with a container holding a cleaning solution. Operation of the pump 14 pumps the cleaning solution through the product flow control assembly 32, the product line segment 41, the mixing line segment 45, and the dispensing unit 11 including an opened faucet 57, thereby cleaning the product flow control assembly 32, the product line segment 41, the mixing line segment 45, and the dispensing unit 11. After pumping the cleaning solution, the pump 14 may be connected with a container holding water, which is then pumped to flush any residual cleaning solution from the product flow control assembly 32, the product line segment 41, the mixing line segment 45, and the dispensing unit 11. While the dispenser 10 may be cleaned without disassembly, it should be understood by one of ordinary skill in the art that the dispenser 10 may be disassembled for the complete cleaning of each component.

Although the present invention has been described in terms of the foregoing preferred embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

1. A dispenser of nitrogen gas infused cold brew beverages, comprising:
a product container;
a nitrogenator coupled with a nitrogen gas source and a water source, wherein the nitrogenator receives water from the water source and nitrogen gas from the nitrogen gas source and infuses the nitrogen gas into the water to produce nitrogen gas infused water;
a mixing unit coupled with the product container to receive product therefrom and with the nitrogenator to receive nitrogen gas infused water therefrom, wherein the mixing unit combines the product and the nitrogen gas infused water to induce a mixing thereof that creates a nitrogen gas infused beverage; and
a dispensing unit coupled with the mixing unit to receive nitrogen gas infused beverage therefrom, wherein the dispensing unit chills the nitrogen gas infused beverage to produce a nitrogen gas infused cold brew beverage for dispensing therefrom.

2. The dispenser of nitrogen gas infused cold brew beverages according to claim 1, the mixing unit, comprising:
a product flow control assembly coupled with the product container to receive product therefrom;
a nitrogenated water flow control assembly coupled with the nitrogenator to receive nitrogen gas infused water therefrom; and
a mixer coupled with the product flow control assembly to receive product therefrom and with the nitrogenated water flow control assembly to receive nitrogen gas infused water therefrom, wherein the mixer combines the product and the nitrogen gas infused water to induce a mixing thereof that creates a nitrogen gas infused beverage.

3. The dispenser of nitrogen gas infused cold brew beverages according to claim 2, the mixing unit, comprising:
a housing that receives the product flow control assembly, the nitrogenated water flow control assembly, and the mixer therein, and
a cover that fits over the housing to provide a seal therefor.

4. The dispenser of nitrogen gas infused cold brew beverages according to claim 2, the mixer, comprising:
a product line segment having a product inlet coupled with the product flow control assembly to receive product therefrom;
a nitrogenated water line segment having a nitrogenated water inlet coupled with the nitrogenated water flow control assembly to receive nitrogen gas infused water therefrom; and
a mixing line segment, wherein:
the product line segment and the nitrogenated water line segment merge at the mixing line segment,
the mixing line segment contacts the product with the nitrogen gas infused water resulting in the mixing of the product and the nitrogen gas infused water into a nitrogen gas infused beverage, and
the mixing line segment terminates in a beverage outlet coupled with the dispensing unit to deliver nitrogen gas infused beverage thereto.

5. The dispenser of nitrogen gas infused cold brew beverages according to claim 2, the mixer, comprising:
a U-shaped tube including a first inlet coupled with the product flow control assembly to receive product therefrom and a second inlet coupled with the nitrogenated water flow control assembly to receive nitrogen gas infused water therefrom; and
an outlet tube joined with the U-shaped tube wherein the outlet tube contacts the product with the nitrogen gas infused water resulting in the mixing of the product and the nitrogen gas infused water into a nitrogen gas infused beverage, further wherein the outlet tube terminates in a beverage outlet coupled with the dispensing unit to deliver nitrogen gas infused beverage thereto.

6. The dispenser of nitrogen gas infused cold brew beverages according to claim 2, the product flow control assembly, comprising a flow rate controller including an inlet coupled with the product container to receive product therefrom and an outlet coupled with the mixer to deliver product thereto, wherein the flow rate controller is adjustable to increase product flow rate therethrough such that an increasing amount of product delivered to the mixer enhances nitrogen gas infused beverage strength, further wherein the flow rate controller is adjustable to decrease product flow rate therethrough such that a decreasing amount of product delivered to the mixer diminishes nitrogen gas infused beverage strength.

7. The dispenser of nitrogen gas infused cold brew beverages according to claim 2, the product flow control assembly, comprising a flow rate controller including an inlet coupled with the product container to receive product therefrom and an outlet coupled with the mixer to deliver product thereto, wherein:
when a sample of dispensed nitrogen gas infused cold brew beverage indicates insufficient strength thereof, adjustment of the flow rate controller to increase product flow rate therethrough delivers an increasing amount of product to the mixer thereby enhancing nitrogen gas infused cold brew beverage strength, and
when a sample of dispensed nitrogen gas infused cold brew beverage indicates excess strength thereof, adjustment of the flow rate controller to decrease product flow rate therethrough delivers a decreasing amount of product to the mixer thereby diminishing nitrogen gas infused cold brew beverage strength.

8. The dispenser of nitrogen gas infused cold brew beverages according to claim 6, the product flow control assembly, further comprising:
a shut-off valve including an inlet coupled with the product container to receive product therefrom and a product outlet coupled with the inlet of the flow controller, wherein the shut-off valve includes an open position that allows product flow to the flow controller and a closed position that blocks product flow to the flow controller; and
a check valve including an inlet coupled with the outlet of the flow controller and an outlet coupled with the mixer, wherein the check valve permits product flow to the mixer while preventing back-flow of product or nitrogen gas infused water to the flow controller.

9. The dispenser of nitrogen gas infused cold brew beverages according to claim 2, the nitrogenated water flow control assembly, comprising a flow rate controller including an inlet coupled with the nitrogenator to receive nitrogen gas infused water therefrom and an outlet coupled with the mixer to deliver nitrogen gas infused water thereto, wherein the flow rate controller is adjustable to increase nitrogen gas infused water flow rate therethrough such that an increasing amount of nitrogen gas infused water delivered to the mixer diminishes nitrogen gas infused beverage strength, further wherein the flow rate controller is adjustable to decrease nitrogen gas infused water flow rate therethrough such that a decreasing amount of nitrogen gas infused water delivered to the mixer enhances nitrogen gas infused beverage strength.

10. The dispenser of nitrogen gas infused cold brew beverages according to claim 2, the nitrogenated water flow control assembly, comprising a flow rate controller including an inlet coupled with the nitrogenator to receive nitrogen gas infused water therefrom and an outlet coupled with the mixer to deliver nitrogen gas infused water thereto, wherein:
when a sample of dispensed nitrogen gas infused cold brew beverage indicates excess strength thereof, adjustment of the flow rate controller to increase nitrogen gas infused water flow rate therethrough delivers an increasing amount of nitrogen gas infused water to the mixer thereby diminishing nitrogen gas infused cold brew beverage strength, and
when a sample of dispensed nitrogen gas infused cold brew beverage indicates insufficient strength thereof, adjustment of the flow rate controller to decrease nitrogen gas infused water flow rate therethrough delivers a decreasing amount of nitrogen gas infused water to the mixer thereby enhancing nitrogen gas infused cold brew beverage strength.

11. The dispenser of nitrogen gas infused cold brew beverages according to claim 10, the product flow control assembly, further comprising:
a regulator including an inlet coupled with the nitrogenator to receive nitrogen gas infused water therefrom and an outlet coupled with the inlet of the flow controller, wherein the regulator ensures nitrogen gas infused water pressure does not exceed a desired pressure;
a shut-off valve including an inlet coupled with the outlet of the regulator and an outlet coupled with the inlet of the flow controller, wherein the shut-off valve includes an open position that allows nitrogen gas infused water flow to the flow controller and a closed position that blocks nitrogen gas infused water flow to the flow controller; and
a check valve including an inlet coupled with the outlet of the flow controller and an outlet coupled with the mixer, wherein the check valve permits nitrogen gas infused water flow to the mixer while preventing back-flow of product or nitrogen gas infused water to the flow controller.

12. The dispenser of nitrogen gas infused cold brew beverages according to claim 1, the dispensing unit, comprising:
a housing;
a cooling system disposed in the housing, the cooling system coupled with the mixing unit to receive nitrogen gas infused beverage therefrom, wherein the cooling system chills the nitrogen gas infused beverage to produce a nitrogen gas infused cold brew beverage; and
a faucet disposed on the housing, wherein the faucet is coupled with the cooling system to control delivery of nitrogen gas infused cold brew beverage therefrom.

13. The dispenser of nitrogen gas infused cold brew beverages according to claim 1, further comprising a pump coupled between the product container and the mixing unit to deliver product from the product container to the mixing unit.

14. The dispenser of nitrogen gas infused cold brew beverages according to claim 13, wherein decoupling the pump from the product container and coupling the pump with a cleaning solution container permits pumping of cleaning solution through the pump, the mixing unit, and the dispensing unit to facilitate cleaning thereof.

15. The dispenser of nitrogen gas infused cold brew beverages according to claim 14, the nitrogenator, comprising:
a water regulator including an inlet coupled with the water source and an outlet therefrom, wherein the water regulator ensures water pressure does not exceed a desired pressure;
a water pump including an inlet coupled with the outlet of the water regulator and an outlet therefrom; and
a tank including a water inlet coupled with the outlet of the water pump to receive water therefrom and a gas inlet coupled with the nitrogen gas source to receive gas therefrom, wherein the tank contacts the nitrogen gas with the water and induces infusion of the nitrogen gas into the water to produce nitrogen gas infused water.

16. The dispenser of nitrogen gas infused cold brew beverages according to claim 15, the nitrogen gas source, comprising:
a canister filled with nitrogen gas; and
a gas regulator, including:
a product side regulator coupled with the pump to deliver nitrogen gas thereto at a desired pressure, wherein the pump is gas powered and driven by the nitrogen gas delivered thereto, and
a nitrogenator side regulator coupled with the gas inlet of the tank to deliver nitrogen gas thereto at a desired pressure.

17. A method of dispensing nitrogen gas infused cold brew beverages, comprising:
infusing nitrogen gas into water to produce nitrogen gas infused water;
delivering product to a mixing unit;
delivering nitrogen gas infused water to the mixing unit;
inducing a mixing of product and nitrogen gas infused water utilizing the mixing unit to create a nitrogen gas infused beverage;
delivering the nitrogen gas infused beverage to a dispensing unit;
cooling the nitrogen gas infused beverage to produce a nitrogen gas infused cold brew beverage; and
dispensing the nitrogen gas infused cold brew beverage.

18. The method of dispensing nitrogen gas infused cold brew beverages according to claim 17, wherein delivering product to a mixing unit, comprises:
delivering product to a product flow control assembly of the mixing unit; and
adjusting product flow rate using the product flow control assembly, wherein increasing product flow rate delivers an increasing amount of product thereby enhancing nitrogen gas infused beverage strength, further wherein decreasing product flow rate delivers a decreasing amount of product thereby diminishing nitrogen gas infused beverage strength.

19. The method of dispensing nitrogen gas infused cold brew beverages according to claim 17, wherein delivering product to a mixing unit, comprises:
delivering product to a product flow control assembly of the mixing unit;
sampling a dispensed nitrogen gas infused cold brew beverage to determine a strength thereof;
increasing product flow rate using the product flow control assembly in response to a determination of insufficient strength wherein an increased product flow rate delivers an increasing amount of product thereby enhancing nitrogen gas infused cold brew beverage strength; and
decreasing product flow rate using the product flow control assembly in response to a determination of excess strength wherein a decreased product flow rate delivers a decreasing amount of product thereby diminishing nitrogen gas infused cold brew beverage strength.

20. The method of dispensing nitrogen gas infused cold brew beverages according to claim 17, wherein delivering nitrogen gas infused water to a mixing unit, comprises:
delivering nitrogen gas infused water to a nitrogenated water flow control assembly of the mixing unit; and
adjusting nitrogen gas infused water flow rate using the nitrogenated water flow control assembly, wherein increasing nitrogen gas infused water flow rate delivers an increasing amount of nitrogen gas infused water thereby diminishing nitrogen gas infused beverage strength, further wherein decreasing nitrogen gas infused water flow rate delivers a decreasing amount of nitrogen gas infused water thereby enhancing nitrogen gas infused beverage strength.

21. The method of dispensing nitrogen gas infused cold brew beverages according to claim 17, wherein delivering nitrogen gas infused water to a mixing unit, comprises:
delivering nitrogen gas infused water to a nitrogenated water flow control assembly of the mixing unit;
sampling a dispensed nitrogen gas infused cold brew beverage to determine a strength thereof;
increasing nitrogen gas infused water flow rate using the nitrogenated water flow control assembly in response to a determination of excess strength wherein an increased nitrogen gas infused water flow rate delivers an increasing amount of nitrogen gas infused water thereby diminishing nitrogen gas infused cold brew beverage strength; and
decreasing nitrogen gas infused water flow rate using the nitrogenated water flow control assembly in response to a determination of insufficient strength wherein a decreased nitrogen gas infused water flow rate delivers a decreasing amount of nitrogen gas infused water thereby enhancing nitrogen gas infused cold brew beverage strength.

22. The method of dispensing nitrogen gas infused cold brew beverages according to claim 17, further comprising:
delivering product to a product flow control assembly of the mixing unit;
delivering nitrogen gas infused water to a nitrogenated water flow control assembly of the mixing unit;
merging the product flow control assembly and the nitrogenated water flow control assembly at a mixer of the mixing unit; and
inducing a mixing of product and nitrogen gas infused water utilizing the mixer to create a nitrogen gas infused beverage.

23. The method of dispensing nitrogen gas infused cold brew beverages according to claim 17, further comprising:
delivering product to a product flow control assembly of the mixing unit;
delivering nitrogen gas infused water to a nitrogenated water flow control assembly of the mixing unit;
delivering product from the product flow control assembly to a first inlet of a U-shaped tube;
delivering nitrogen gas infused water from the nitrogenated water flow control assembly to a second inlet of the U-shaped tube;
delivering product and nitrogen gas infused water from the U-shaped tube to an outlet tube joined with the U-shaped tube; and
inducing a mixing of product and nitrogen gas infused water utilizing the outlet tube to create a nitrogen gas infused beverage.

24. The method of dispensing nitrogen gas infused cold brew beverages according to claim 17, further comprising:
ceasing delivery of product to the mixing unit;
delivering a cleaning solution to the mixing unit;
delivering the cleaning solution from the mixing unit to the dispensing unit; and
dispensing the cleaning solution from the dispensing unit thereby cleaning the mixing unit and the dispensing unit.
